(19) United States
(12) Patent Application Publication
(10) Pub. No.: US 2025/0259241 A1
(43) Pub. Date: Aug. 14, 2025

(54) Global Economic and Life Solution System and Its Implementation Method Based on the BEI_24HWS Human Sovereignty Ecosystem

(71) Applicant: FURONG BEI, SAN GABRIEL, CA (US)

(72) Inventor: FURONG BEI, SAN GABRIEL, CA (US)

(21) Appl. No.: 19/196,763

(22) Filed: May 2, 2025

(51) Int. Cl. G06Q 40/06; G06Q 40/02; G06Q 50/26

(52) U.S. Cl. CPC G06Q 40/06; G06Q 40/02; G06Q 50/26

(57) ABSTRACT

A human-centric global sovereignty ecosystem (BEIx24HWS) combining fractal domain naming, behavior-energy tokenization, hybrid governance, instant DeFi, AI optimization, and sustainable certification. Simulated annual token output exceeds 303 trillion USD, creating over 6 billion jobs and enabling an inclusive, sustainable economic model for 8.2 billion users.

### TECHNICAL FIELD

The present invention relates to blockchain-based token-economy systems integrating human behavioral data, domain-name identity, and resource management into a unified global platform with hybrid governance and AI-blockchain optimization.

### BACKGROUND OF THE INVENTION

1. Centralized Internet and financial platforms (e.g., Amazon, SWIFT) limit user sovereignty and equitable value distribution.
2. Existing Web3 solutions address narrow use cases without an inclusive, closed-loop economy spanning all human needs and resources.
3. Prior ReadName domain reservations lacked real-time resolution, token mapping, and governance.

### SUMMARY OF THE INVENTION

The BEIx24HWS ecosystem:
Registers 1,600 top-level ReadName domains across 999 needs and 365 industries for 8.2 billion users.
Uses a BEI behavior-energy chip to capture actions, mapped via a tensor E_fb formula, issuing tradable tokens R(t)=(1+λ·E_fb)\hat{ }κ.
Employs hybrid DAO+centralized governance, multi-factor security, and smart-contract enforcement.
Integrates ATMS.com/168Bank.com for instant DeFi and BxAI for parameter optimization.
Implements Green Organic Mine NFT mining for sustainable certification and token amplification.

### DETAILED DESCRIPTION OF THE INVENTION

1. ReadName fractal domain module for dynamic ecosystem expansion.
2. BEI chip data acquisition with edge gateways.
3. Tensor mapping and energy-to-token algorithm.
4. Smart-contract DAO governance.
5. Real-time finance (ATMS.com/168Bank.com) and cross-chain atomic swaps.
6. AI-blockchain optimizer (BxAI).
7. Privacy/security: time-rollback, kill-switch, zk-SNARK audit resistance.
8. Dynamic fractal expansion N_total=N_base×k\hat{ }d.
9. International integration with 100+ organizations, GDPR/KYC compliance.

### BRIEF DESCRIPTION OF THE DRAWINGS

FIG. 1: System Architecture

FIG. 2: Energy Mapping Flow

FIG. 3: Fractal Expansion Model

FIG. 4: Governance Layer Diagram

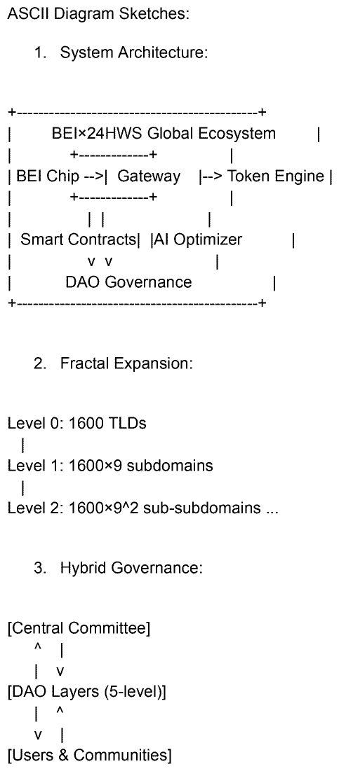

### COMPARATIVE ANALYSIS

| | BEI × 24HWS | United States | China | European Union |
|---|---|---|---|---|
| Metric | Ecosystem | (2024) | (2024) | (2024) |
| Annual Token | 303,000 billion | 26,700 billion | 18,000 billion | 18,600 billion |
| Output (USD) | USD | USD | USD | USD |
| Per Capita | 37,000 | 80,000 | 12,700 | 42,000 |
| Output (USD) | | | | |
| Money Supply | 90,000 billion | 21,500 billion | 43,000 billion | 14,000 billion |
| (M2) | USD¹ | USD² | USD³ | USD⁴ |
| Jobs Created | 6,060 | 160 | 780 | 200 |
| (millions) | | | | |

### Data Sources and Calculation Basis

1. BEIx24HWS metrics based on Implementation Example 21 and Calculation Methodology, 8.2 billion users.
2. U.S. GDP & Per Capita: IMF WEO April 2025.
3. China GDP, M2: World Bank 2024; PBOC December 2024.
4. EU GDP, M3: Eurostat 2024; ECB December 2024.
¹Money Supply M2: aggregated globally for BEIx24HWS study.
²U.S. Federal Reserve; ³People's Bank of China; ⁴European Central Bank.

### Deployment & Support Materials

To facilitate global adoption and meeting diverse national and regulatory requirements, the following support documents will be provided:
1. Localized Whitepapers: Customized policy and strategy recommendations tailored to each country's regulatory and economic priorities.
2. Compliance Technical Reports: Detailed mappings to central bank frameworks, financial regulations, data privacy laws, and cybersecurity standards in each jurisdiction.
3. Demonstration Zone Implementation Plans: Quantitative targets, KPIs, and pilot rollout roadmaps for special economic zones or innovation districts.
4. Multilingual UX Integration: Localized ReadName registration portals and BEI chip management interfaces, supporting regional languages and cultural contexts.

### Implementation Example 32: Defensive and Collaborative AI Strategies

To anticipate and mitigate challenges by external AI entities and maintain system integrity, the following strategies are integrated into the patent framework:

### 1. Code-Level Review and Pseudocode Appendix

Provide detailed pseudocode of core algorithms (E_fb computation, tensor mapping, token issuance) in an annex, enabling transparent third-party auditing without exposing proprietary implementation.

### 2. Performance Benchmarking Protocols

Establish standard test suites comparing BEIx24HWS modules against existing DeFi protocols, DAO frameworks, and AI optimization engines; publish results as living documents.

### 3. Formal Security Audit Framework

Integrate formal verification toolchains (e.g., TLA+, Coq) for smart-contract modules (zk-SNARK reconciliation, kill-switch, rollback); require certificates of audit for major releases.

### 4. Iterative Parameter Optimization and Governance

Implement on-chain governance proposals enabling real-time adjustment of λ, κ, γ, and tensor decomposition parameters, ensuring continuous resilience and performance tuning.

### 5. Cross-Model Collaboration and Federated Learning Interface

Define secure APIs and federated learning protocols allowing external AI models to contribute to global optimizer without accessing raw user data; include differential privacy safeguards.

### 6. AI Council Oversight and Rapid Response Team

Charter an AI Council via DrAIGlobal.com DAO to monitor external AI developments, propose patches, and coordinate rapid upgrade deployments across nodes.

These strategies ensure that the BEIx24H WS ecosystem remains secure, performant, and collaborative in the face of evolving external AI comparisons and adversarial analyses.

1. System claim: An integrated global ecosystem system based on BEIx24HWS, comprising:
a. a fractal ReadName domain management module registering and resolving top-level and recursive subdomains;
b. a BEI behavior-energy chip data acquisition module capturing active and passive user actions;
c. a high-dimensional energy mapping and token issuance module implementing energy-to-token mapping;
d. a hybrid governance module combining decentralized DAO voting and centralized strategy committees;
e. an integrated real-time finance module (ATMS.com/168Bank.com);
f. an AI-blockchain optimization module (BxAI); and
g. a “Green Organic Mine” sustainable certification token mining mechanism.

2. Method claim: A method of operating the system of claim 1, comprising:
a. capturing user behavior data via the BEI chip;
b. mapping behavior-energy into multi-dimensional tensors;
c. issuing tokens according to the formula R(t)=(1+λ× E_fb)\hat{ }κ;
d. executing DAO governance decisions;
e. performing real-time financial transactions; and
f. optimizing system parameters via AI-blockchain federated learning.

3. Computer-Readable Medium claim: A non-transitory computer-readable medium storing instructions that, when executed by a processor, perform the method of claim 2.

4. The system of claim 1, wherein the energy mapping module dynamically adjusts issuance parameters via federated learning and smart contract feedback loops.

5. The system of claim 1, further comprising a privacy and security framework including:
a. blockchain-based time rollback snapshots;
b. privacy kill-switch data destruction; and
c. zk-SNARK audit-resistant verification with multi-factor reconciliation.

6. The system of claim 1, wherein fractal expansion of ReadName subdomains follows N_total=N_base×k\hat{ }d with adaptive tuning.

7. The system of claim 1, wherein multi-scale simulation employs agent-based modeling and Monte Carlo sampling for parameter calibration.

8. The system of claim 1, wherein cross-chain compliance is achieved via IBC/Cosmos and decentralized Oracles for KYC/AML and GDPR.

9. The system of claim 1, wherein hybrid governance requires >50% DAO member approval and ⅗ institutional committee approval for global policy enactment.

10. The system of claim 1, wherein each user is allocated one free BEI terminal, ten land reserves, eight thousand vaults, and 1,095 virgin lands.

11. The system of claim 1, wherein the BEI chip replaces SIM card functionality to enable encrypted global communication without telecommunication carriers.

12. The system of claim 1, wherein financial transactions settle in less than one second with fees below 0.1% using cross-chain atomic swaps and multi-signature validations.

13. The system of claim 1, wherein 365 industry-specific shard networks support parallel deployment of user nodes across finance, healthcare, education, retail, manufacturing, and other sectors.

14. The system of claim 1, further comprising an individual sovereignty command center for each user, providing real-time monitoring of ecosystem status, token balances, and governance participation.

15. The system of claim 1, wherein a tiered promotion mechanism advances users through personal, family, community, regional, and global governance roles based on performance metrics.

16. The system of claim 1, wherein initial resource allocations and terminals expand fractally based on user demand and ecosystem health metrics through smart contract enforcement.

17. The system of claim 1, wherein over 100 international organizations integrate via ReadName subdomains and standardized taxonomy for cross-organization governance collaboration.

18. The system of claim 1, wherein DrAIGlobal.com federated AI governance platform schedules AI services and updates via DAO-elected AI Councils.

19. The system of claim 1, wherein culture strategies from 36G.com inject localized historical and spiritual context into AI decision-making models.

20. The system of claim 1, wherein the multi-dimensional interaction tensor T[user][ecosystem][demand][industry][resource]is decomposed using CP or Tucker methods for real-time data analytics.
